(19) United States
(12) Patent Application Publication
(10) Pub. No.: US 2009/0033288 A1
(43) Pub. Date: Feb. 5, 2009

(54) CHARGING CONTROL DEVICE FOR VEHICLE

(76) Inventors: Yukiyasu Takano, Shizuoka-ken (JP); Hiroshi Hirano, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/848,384

(22) Filed: Aug. 31, 2007

(30) Foreign Application Priority Data
Sep. 4, 2006 (JP) JP2006-239601

(51) Int. Cl. H02J 7/00

(52) U.S. Cl. 320/137

(57) ABSTRACT

To reduce the size and weight of a vehicle including a battery and a charger, which is not mounted on the vehicle, for charging the battery with a charging current supplied from a power source.

A vehicle 1 includes a battery 3 for discharging electricity to an electric motor 2 for driving the vehicle 1 to run. A charger 10 that is not mounted on the vehicle 1 is provided. The charger 10 can charge the battery 3 with a charging current supplied from a power source 8. At least one of the vehicle 1 and the charger 10 includes a charging storage device 18, 20 for storing charging history of the battery 3. The battery 3 is charged via the charger 10 based on the charging history stored in the charging storage device 18, 20.

### TECHNICAL FIELD

The present invention relates to a charging control device for a vehicle that can efficiently charge an onboard battery by control based on the previous charging history of the battery.

### BACKGROUND ART

A conventional charging control device for a vehicle is disclosed in Patent Document 1 mentioned below. The vehicle according to the publication is a golf cart, and includes an electric motor for driving the vehicle to run, a battery for discharging (supplying) electricity to the electric motor, and a motor controller for controlling the electricity supplied from the battery to the electric motor to a desired value in response to the amount of operation input to an operation section such as an accelerator pedal by a golfer.

The above conventional charging control device for a vehicle may be configured as follows. There are provided a charger, which is not mounted on the vehicle, for charging the battery with a charging current from a power source, and a charging condition detection device, which is mounted on the vehicle, for detecting the condition of charging (value of the charging current) from the power source to the battery.

In general, the vehicle is used on a golf course as follows. First, a golfer gets on the vehicle, and operates the operation section such as an accelerator pedal. Then, a desired amount of electricity is supplied from the battery to the electric motor in response to the amount of operation input to the operation section under control by the motor controller, so as to drive the electric motor. As the electric motor is driven in this way, the vehicle can be run at a speed desired by the operator.

The above vehicle departs from a predetermined location on a golf course, is used during a day's round of golf, and then is returned to the predetermined location. In this case, electricity in the battery of the vehicle has been discharged to the electric motor, and reduced to about 80%, in general, of the electricity storage capacity. Therefore, the battery is charged via the charger by control based on a detection signal from the charging condition detection device. The battery is charged to its full capacity, in general, so that the battery can discharge sufficient electricity to the electric motor the next day.

[Patent Document 1] JP-A-2004-221521

### DISCLOSURE OF THE INVENTION

### [Problem to be Solved by the Invention]

In general, vehicles are desired to be small, and therefore have a limited vacant space inside. In addition, vehicles are required to be lightweight, so that a smaller battery with a lower electricity storage capacity would be sufficient. However, in the related art described above, the vehicle is provided with the charging condition detection device. Therefore, the size and weight of the vehicle are accordingly increased, disadvantageously making it difficult for the above requirements to be met.

### [Means for Solving the Problem]

The present invention has been made in view of the foregoing circumstances, and therefore has an object to reduce the size and weight of a vehicle including a battery and a charger, which is not mounted on the vehicle, for charging the battery with a charging current supplied from a power source.

The invention of claim 1 provides a charging control device for a vehicle 1, the vehicle 1 including a battery 3 for discharging electricity to an electric motor 2 for driving the vehicle 1 to run, and a charger 3, which is not mounted on the vehicle 1, for charging the battery 3 with a charging current supplied from a power source 8,

characterized in that at least one of the vehicle 1 and the charger 10 includes a charging storage device 18, 20 for storing charging history of the battery 3, so that the battery 3 is charged via the charger 10 based on the charging history stored in the charging storage device 18, 20.

The invention of claim 2 provides the invention of claim 1, in which a data signal representing the charging history stored in the charging storage device 18, 20 can be output to a display device 22 to display the charging history on the display device 22.

The invention of claim 3 provides the invention of claim 1 or 2, in which the vehicle 1 is a golf cart.

Reference numerals and symbols attached to the terms in this section are not intended to limit the technical scope of the present invention to the description in the “Embodiment” section below and the drawings.

### [Effect of the Invention]

The effect of the present invention is as follows.

The invention of claim 1 provides a charging control device for a vehicle, the vehicle including a battery for discharging electricity to an electric motor for driving the vehicle to run, and a charger, which is not mounted on the vehicle, for charging the battery with a charging current supplied from a power source,

characterized in that at least one of the vehicle and the charger includes a charging storage device for storing charging history of the battery, so that the battery is charged via the charger based on the charging history stored in the charging storage device.

Here, in the related art described above, the vehicle is provided with a charging condition detection device for detecting the condition of charging from the power source to the battery to allow the battery to be efficiently charged via the charger by control based on the detection signal.

However, with the above invention, the battery is charged simply based on the charging history stored, and there is no need for the charging condition detection device described above.

Therefore, the absence of the charging condition detection device on the vehicle contributes to a reduction in the size and weight of the vehicle, allowing a reduction in the capacity of the electric motor and the battery. In addition, the vehicle can be offered at a lower price.

In the invention of claim 2, a data signal representing the charging history stored in the charging storage device can be output to a display device to display the charging history on the display device.

Therefore, the operator can be easily informed of the charging history at an earlier stage by seeing the display device.

This firstly allows a new charging mode to be set in advance and more suitably based on the charging history, allowing efficient charging. As a result, the battery and the electric motor driven thereby can be more fully utilized. Secondly, an abnormality that has occurred in the battery and the charger can be treated at an earlier stage.

In the invention of claim 3, the vehicle is a golf cart.

Here, golf carts are sometimes required to run along a narrow passage with a large steering angle on a golf course, where there may be large ups and downs. Therefore, golf carts are desired to be compact and lightweight.

Therefore, it is extremely advantageous to apply the configuration of the invention of claim 1, that the battery is charged via the charger based on the charging history stored in the charging storage device, to golf carts, which are preferably compact and lightweight.

### BEST MODE FOR CARRYING OUT THE INVENTION

In order to achieve an object to reduce the size and weight of a vehicle including a battery and a charger, which is not mounted on the vehicle, for charging the battery with a charging current supplied from a power source by using the charging control device for a vehicle according to the present invention, the best mode for carrying out the invention is as follows.

A vehicle includes a battery for discharging electricity to an electric motor for driving the vehicle to run. A charger that is not mounted on the vehicle is provided. The charger can charge the battery with a charging current supplied from the power source. At least one of the vehicle and the charger includes a charging storage device for storing charging history of the battery. The battery is charged via the charger based on the charging history stored in the charging storage device.

### EMBODIMENT

In order to describe the invention in more detail, an embodiment thereof is hereinafter described with reference to the accompanying drawings.

In FIG. 1, reference numeral 1 denotes an electric vehicle that can run on a golf course, for example a golf cart.

The vehicle 1 includes an electric motor 2, supported by a vehicle body (not shown), for driving the vehicle to run, a lead battery 3 for discharging (supplying) electricity to the motor 2, an operation section 4 such as an accelerator pedal to be operated by an operator such as a golfer, and a motor controller 5 for electronically controlling the discharge amount of electricity from the battery 3 to the electric motor 2 to a desired value in response to the amount of operation input to the operation section 4 to drive the electric motor 2 into a desired state. The motor controller 5 includes a central processing unit (CPU) 6.

A charger 10 that is not mounted on the vehicle 1 is provided. The charger 10 receives electricity supplied from a power source 8 via a connector 9, and can charge the battery 3 with a charging current. The charger 10 includes a central processing unit (CPU) 11. The power source 8 is a commercial power source (100 VAC, 50/60 Hz) provided at a charging stand on a golf course.

A connector 14 that can connect/disconnect the battery 3 and the central processing unit 6 of the motor controller 5 to/from the charger 10 is provided. The connector 14 includes an input terminal 15 that is a receptacle provided on the side of the battery 3 and the motor controller 5, and an output terminal 16 that is a plug provided on the side of the charger 10 and connectable with the input terminal 15.

The input terminal 15 has three plug sockets 15a, 15b, 15c, while the output terminal 16 has three plugs 16a, 16b, 16c corresponding to the plug sockets 15a, 15b, 15c, respectively. Connecting two plug sockets 15a, 15b, of the plug sockets 15a, 15b, 15c, and two plugs 16a, 16b, of the plugs 16a, 16b, 16c, to each other allows the battery 3 to be charged with a charging current supplied from the power source 8 via the charger 10. Connecting the other plug socket 15c, of the plug sockets 15a, 15b, 15c, and the other plug 16c, of the plugs 16a, 16b, 16c, to each other allows electronic communication between the central processing unit 6 of the motor controller 5 and the central processing unit 11 of the charger 10.

Connecting the input terminal 15 and the output terminal 16 of the connector 14 allows the charging current supplied from the power source 8 to be controlled by the central processing unit 11 of the charger 10, allowing the battery 3 to be charged with the charging current via the plug sockets 15a, 15b and the plugs 16a, 16b of the connector 14.

The charger 10 includes a charging storage device 18 for storing previous charging history of the battery 3. The term “charging history” as used above refers to data of charging records such as charging current, charging time, etc., during the charging. In order to identify which one of a plurality of vehicles 1 available at a golf course corresponds to the charging history of the battery 3 stored in the charging storage device 18, an identification code of each vehicle 1 is stored in the charging storage device 18 along with the charging history. The charging storage device 18 of the charger 10 may not be able to identify which vehicle 1 is used during the charging.

The motor controller 5 includes a separate charging storage device 20 for storing previous charging history of the battery 3. Specifically, the charging history stored in the charging storage device 18 is sent as it is via the central processing unit 11 of the charger 10, the plug socket 15c and the plug 16c of the connector 14, and the central processing unit 6 of the motor controller 5 to be stored in the separate charging storage device 20.

During the charging, a signal output from the central processing unit 11 of the charger 10 may not be stored in the charging storage device 18 but be sent via the plug socket 15c and the plug 16c of the connector 14 and the central processing unit 6 of the motor controller 5 to be stored directly in the separate charging storage device 20. In this case, the charging storage device 18 may not be provided.

A display device 22 that is not mounted on the vehicle 1 is provided. The display device 22 may be a stationary personal computer or a portable information terminal that may be a personal computer. A connector 23 that can connect the central processing unit 6 of the motor controller 5 and the display device 22 to each other is provided. The connector 23 includes an input terminal 24 that is a receptacle provided on the side of the display device 22, and an output terminal 25 that is a cap provided on the side of the central processing unit 6 of the motor controller 5 and connectable with the input terminal 24.

A data signal representing the charging history stored in the separate charging storage device 20 and so forth can be output via the connector 23 to the display device 22. Outputting the data signal allows the charging history and information such as charging mode during the charging to be visibly displayed on the display device 22. The data signal may be output wirelessly from the central processing unit 6 of the motor controller 5 to the display device 22. The charging history stored in the charging storage device 18 may be displayed on the display device 22.

In order to charge anew the battery 3 of the vehicle 1 with the charging current supplied from the power source 8, first, the input terminal 15 and the output terminal 16 of the connector 14 are connected. Then, charging is performed anew in a new charging mode set based on the previous charging history stored in the separate charging storage device 20 of the motor controller 5 provided to the vehicle 1.

Specifically, in the case where the vehicle 1 departed from a predetermined value, and has run approximately a predetermined distance over approximately a predetermined time without trouble to return to the predetermined location, the battery 3 is charged anew by the charger 10 using a new charging mode with the same charging current and the same charging time as those of the previous charging history stored in either of the charging storage devices 18, 20. The charging history of this charging anew is stored in the charging storage devices 18, 20 as previous charging history.

Now, in the case where a trouble has occurred, for example the amount of electricity stored in the battery 3 is short, during subsequent running of the vehicle 1 under similar conditions to those described above, a new charging mode is set externally by an operation by an operator or automatically by the central processing unit 11 of the charger 10. In the new charging mode, the charging current may be increased or the charging time may be increased, for example, compared to the previous charging history stored in either of the charging storage devices 18, 20. Then, the battery 3 is charged further anew in this further new charging mode.

Here, in the case where the amount of electricity stored in the battery 3 is abnormally short during running of the vehicle 1, it is determined that an abnormality has occurred in the battery 3 or the charger 10.

While the battery 3 of the vehicle 1 is being charged, the charging storage device 18 of the charger 10 identifies which one of the plurality of vehicles 1 the subject vehicle 1 is, as described above. This allows the charging storage device 18 to extract the charging history of the identified vehicle 1. Therefore, in this case, it is not necessary to mount a separate charging storage device 20 on each vehicle 1, in other words, the separate charging storage device 20 may not be provided. In the case where there is only one vehicle 1 as a charging object of the charger 10, the charging history may be stored in only one of the charging storage devices 18, 20.

With the above configuration, at least one of the vehicle 1 and the charger 10 includes the charging storage device 18, 20 for storing the charging history of the battery 3, so that the battery 3 is charged via the charger 10 based on the charging history stored in the charging storage device 18, 20.

Here, in the related art described above, the vehicle is provided with a charging condition detection device for detecting the condition of charging from the power source to the battery to allow the battery to be efficiently charged via the charger by control based on the detection signal.

However, with the above configuration, the battery 3 is charged simply based on the charging history stored, and there is no need for the charging condition detection device described above.

Therefore, the absence of the charging condition detection device on the vehicle 1 contributes to a reduction in the size and weight of the vehicle 1, allowing a reduction in the capacity of the electric motor 2 and the battery 3. In addition, the vehicle 1 can be offered at a lower price.

Moreover, as described above, the data signal representing the charging history stored in the charging storage device 18, 20 can be output to the display device 22 to display the charging history on the display device 22.

Therefore, the operator can be easily informed of the charging history at an earlier stage by seeing the display device 22.

This firstly allows a new charging mode to be set in advance and more suitably based on the charging history, allowing efficient charging. As a result, the battery 3 and the electric motor 2 driven thereby can be more fully utilized. Secondly, an abnormality that has occurred in the battery 3 and the charger 10 can be treated at an earlier stage.

Furthermore, as described above, the vehicle 1 is a golf cart.

Here, golf carts are sometimes required to run along a narrow passage with a large steering angle on a golf course, where there may be large ups and downs. Therefore, golf carts are desired to be compact and lightweight.

Therefore, it is extremely advantageous to apply the above configuration, that the battery 3 is charged via the charger 10 based on the charging history stored in the charging storage device 18, 20, to golf carts, which are preferably compact and lightweight.

### BRIEF DESCRIPTION OF DRAWINGS

FIG. 1 is an electrical block diagram of a device in accordance with the present invention.

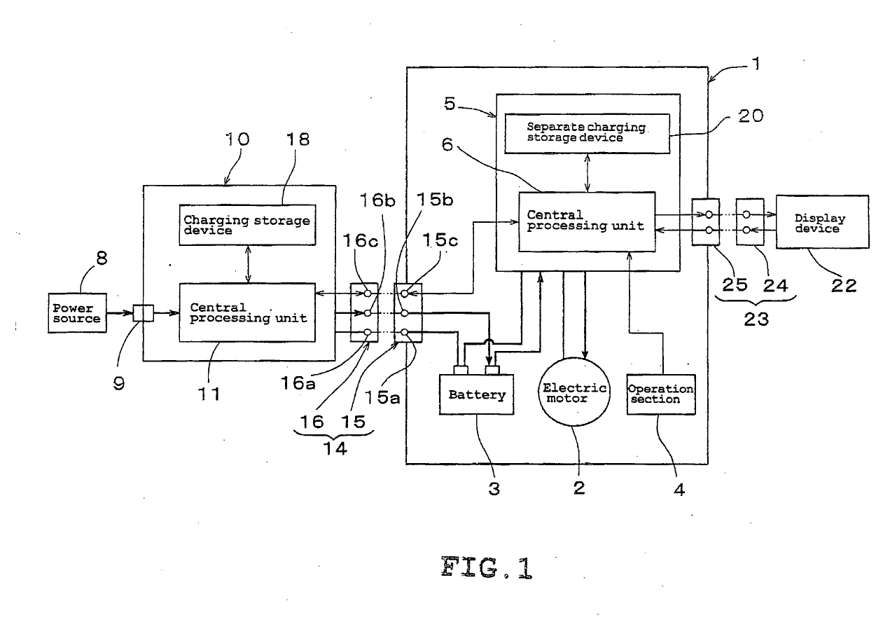

### DESCRIPTION OF REFERENCE NUMERALS

1: vehicle
2: electric motor
3: battery
4: operation section
5: motor controller
8: power source
10: charger
14: connector
15: input terminal
15a: plug socket
15b: plug socket
15c: plug socket
16: output terminal
16a: plug
16b: plug
16c: plug
18: charging storage device
20: separate charging storage device
22: display device
23: connector

1. A charging control device for a vehicle, the vehicle including a battery for discharging electricity to an electric motor for driving the vehicle to run, and a charger, which is not mounted on the vehicle, for charging the battery with a charging current supplied from a power source,
characterized in that at least one of the vehicle and the charger includes a charging storage device for storing charging history of the battery, so that the battery is charged via the charger based on the charging history stored in the charging storage device.

2. The charging control device for a vehicle according to claim 1, wherein a data signal representing the charging history stored in the charging storage device can be output to a display device to display the charging history on the display device.

3. The charging control device for a vehicle according to claim 1 or 2, wherein the vehicle is a golf cart.
